(19) United States
(12) Patent Application Publication
(10) Pub. No.: US 2004/0260029 A1
(43) Pub. Date: Dec. 23, 2004

(54) Polyalkylene oxide-based graft polymers

(76) Inventors: Evgueni Avtomonov, Leverkusen (DE); Burkhard Kohler, Leverkusen (DE); Pierre Vanhoorne, Dusseldorf (DE); Rolf-Volker Meyer, Much (DE)

Correspondence Address: BAYER MATERIAL SCIENCE LLC, 100 BAYER ROAD, PITTSBURGH, PA, 15205, US

(21) Appl. No.: 10/484,786

(22) PCT Filed: Jul. 19, 2002
(86) PCT No.: PCT/EP02/08041

(30) Foreign Application Priority Data
Jul. 26, 2001 (DE) 101 36 447.4

(51) Int. Cl. C08F 269/00; C08F 273/00; C08F 275/00; C08F 265/04; C08F 267/04; C08F 267/06

(52) U.S. Cl. 525/284; 525/285; 525/286; 525/302

(57) ABSTRACT

Graft polymers are disclosed. These are obtainable by polymerization of a mixture containing A) from 40 to 99 wt. % vinyl monomers and B) from 1 to 60 wt. % of a double-bond-containing polyalkylene oxide rubber having a glass transition temperature below −50° C. and a number-average molecular weight of from 25,000 to 10,000,000. The inventive graft polymers are characterized by their very good low-temperature strength and weathering resistance.

The invention relates to graft polymers of vinyl monomers on a base of double-bond-containing polyalkylene oxide rubber, to a process for the preparation of such graft polymers, and to their use.

Graft polymers of vinyl monomers on polydiene rubbers are known and are used in practice on a large scale. Owing to the low glass transition temperature of the rubber phase, they have good low-temperature strength, but they are sensitive to oxidative degradation because the main chain of the rubber contains double bonds.

On the other hand, the low-temperature strength of graft polymers of vinyl monomers on rubbers having a saturated main chain, such as, for example, acrylate rubbers, EP(D)M or LLDPE, is not adequate for all applications, because the glass transition temperatures of such rubbers are mostly above −60° C.

Furthermore, graft polymers in which the rubber phase is not crosslinked exhibit disadvantages in their property profile as compared with those in which the rubber phase is crosslinked. For example, their properties of use also change with their morphology when they are processed.

Graft polymers of vinyl monomers on crosslinkable rubbers, which polymers both have a low glass transition temperature, preferably below −60° C., and are more resistant to weathering than those based on polydiene rubbers, are therefore desirable.

Graft polymers of vinyl monomers on epihalohydrin-containing polyalkylene oxides are known (U.S. Pat. No. 3,632,840, GB-A 1 352 583, GB-A 1 358 184, U.S. Pat. No. 3,627,839). In those polymers, the rubber phase is not crosslinked and the glass transition temperature of that phase is above −50° C.

U.S. Pat. No. 4,500,687 describes impact-modified thermoplastics based on styrene-containing resin matrix and polyalkylene oxide elastomers having a low glass transition temperature (below −60° C.) as graft base. The process is based on the in situ preparation of a very; high molecular weight polyalkylene oxide rubber in toluene and/or styrene monomer as solvent with the aid of specific aluminium-containing catalysts, as well as the free-radical graft polymerisation of the vinyl monomers on that polyalkylene oxide rubber. A disadvantage of the process described in U.S. Pat. No. 4,500,687 is the use of relatively large amounts of catalyst, based on the epoxides, which can lead to faults in the graft polymerisation and to poorer product properties owing to the catalyst residues remaining in the polymer. In addition, the conversions in the epoxide polymerisation are markedly below 100%, typically from 30 to 60%, which necessitates an additional purification step for removal of the toxic epoxides.

The object was, therefore, to provide graft polymers which have very good low-temperature strength and weathering resistance and which do not exhibit the problems mentioned above.

Surprisingly, it has now been found that the object is achieved by graft polymers which are obtainable by polymerisation of a defined mixture of vinyl monomers on specific polyalkylene oxide rubbers.

Accordingly, the invention provides graft polymers which are obtainable by polymerisation of a mixture containing

A) from 40 to 99 wt. %, preferably from 50 to 98 wt. %, particularly preferably from 60 to 97 wt. %, vinyl monomers and

B) from 1 to 60 wt. %, preferably from 2 to 50 wt. %, particularly preferably from 3 to 40 wt. %, of a polyalkylene oxide having a glass transition temperature below −50° C. and a number-average molecular weight of from 25,000 to 10,000,000.

Suitable vinyl monomers according to component A) are, for example, styrene, α-methylstyrene, 3-methylstyrene, 4-methylstyrene, indene, norbornene, acrylonitrile, methacrylonitrile, methyl methacrylate, maleic, anhydride, maleimides, which may be substituted at the nitrogen atom by C₁- to C₁₈-alkyl or C₆- to C₁₀-aryl radicals, (meth)acrylic acid esters having from 1 to 18 carbon atoms in the alcohol component, and glycidyl methacrylate, as well as mixtures of those compounds.

Styrene, acrylonitrile and mixtures thereof are preferred.

Suitable polyalkylene oxide rubbers according to component B) are especially those which are obtainable by reaction of a mixture containing

I) from 80 to 99 parts by weight of one or more saturated epoxides,

II) from 1 to 20 parts by weight, preferably from 2 to 15 parts by weight, particularly preferably from 5 to 10 parts by weight, of one or more unsaturated epoxides,

III) from 0 to 10 parts by weight, preferably from 0 to 5 parts by weight, of epoxides having hydrolytically crosslinkable groups, and

IV) from 0 to 1 part by weight, preferably from 0 to 0.5 part by weight, of one or more diepoxides,

the sum of components I) to IV) being 100 parts by weight,

in the presence of a multi-metal cyanide catalyst.

Suitable saturated epoxides according to component I) are, for example, ethylene oxide, propylene oxide, epoxides of olefins having from 4 to 18 carbon atoms, such as, for example 1-butene oxide, 2-butene oxide, 1-pentene oxide, 2-pentene oxide, isopropyloxirane, hexene oxides, C₁- to C₁₈-alkyl glycidyl ethers, glycidyl esters having from 1 to 18 carbon atoms in the ester radical, as well as mixtures of those compounds. Propylene oxide is preferred. The amount of propylene oxide in component. I) is preferably more than 30 wt. %, particularly preferably more than 50 wt. %.

Suitable unsaturated epoxides according to component II) are, for example, allyl glycidyl ether, butadiene monoepoxide, isoprene monoepoxide, divinylbenzene monoepoxide, isopropenylphenyl glycidyl ether or glycidyl (meth)acrylate, with allyl glycidyl ether and glycidyl (meth)acrylate being preferred.

Suitable epoxides having hydrolytically crosslinkable groups according to component III) are, for example, epoxides having groups such as, for example,

(R¹O)ₙR²₃₋ₙSi— or XₙR²₃₋ₙSi—,

wherein.

R¹ and R² represent identical or different alkyl radicals having from 1 to 20 carbon atoms, preferably C₁-C₆-alkyl, particularly preferably methyl, arylalkyl radicals having from 7 to 26 carbon atoms, preferably aryl-C₁-C₄-alkyl, particularly preferably benzyl, or aryl radicals having from 6 to 20 carbon atoms, preferably C₆-C₁₀-aryl, particularly preferably phenyl,

n represents an integer from 1 to 3, and

X represents a halide.

Examples are the epoxides of formulae III-1 to III-4

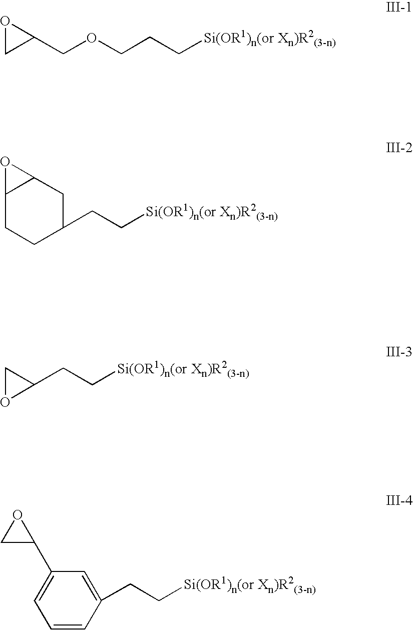

wherein X, R¹, R² and n are as defined above.

Of those, preference is given to glycidyl (3-trimethoxysilylpropyl) ether (formula III-1, R¹=methyl, n=3).

It is also possible, if desired, to add one or more diepoxides according to component IV) in order to increase the molar mass. Suitable diepoxides according to component IV) are, for example, butadiene diepoxide, isoprene diepoxide, hexadiene-2,4-diepoxide, divinylbenzene diepoxide, vinylcyclohexene diepoxide, 1,4-butanediol diglycidyl ether or bisphenol A diglycidyl ether. Vinylcyclohexene diepoxide, 1,4-butane diglycidyl ether and bisphenol A diglycidyl ether are preferred.

The polyalkylene oxides B) that are suitable are obtainable from components I) to IV) by ring-opening polymerisation with catalysis by means of multi-metal cyanide catalysts.

Suitable multi-metal cyanide catalysts are known and are described in the art. Preference is given to catalysts such as are described in EP-A 654 302, EP-A 700 949, EP-A 743 093, EP-A 761 708, WO 97/40086, WO 98/16310 and DE-A 199 20 937. Multi-metal cyanide catalysts containing zinc hexacyanocobaltate(III), zinc hexacyanoiridate(III), zinc hexacyanoferrate(III) or cobalt(II) hexacyano-cobaltate(III) are particularly preferred. Very particular preference is given to those which contain, in addition to a multi-metal cyanide compound (e.g., zinc hexacyano-cobaltate(III)) and tert-butanol, also a polyether having a number-average molecular weight greater than 500 g/mol, and which are substantially amorphous.

The amount of catalyst is usually from 0.0001 to 0.05 wt. %, based on the epoxide monomers. Removal from the polymer is generally not necessary.

The reaction can be carried out continuously or discontinuously, for example in a batch or semi-batch process.

The reaction is generally carried out at temperatures of from 20 to 200° C., preferably in the range from 40 to 180° C., particularly preferably in the range from 80 to 150° C. The reaction can be carried out at total pressures of from 0.001 to 20 bar. It can be carried out without a solvent or in one or more inert organic solvents, such as in aliphatic compounds, such as, for example, pentane, isopentane, hexane, heptane, cyclohexane, isooctane, aromatic compounds, such as, for example, benzene, monochlorobenzene, toluene, ethylbenzene, styrene, o-, m-, p-xylenes, ethers, such as, for example, THF, diethyl ether, tert-butyl methyl ether, ketones, such as, for example, acetone, methyl ethyl ketone, methyl propyl ketone, esters, such as, for example, ethyl acetate, methyl propionate, alkyl (meth)acrylates, nitriles, such as, for example, propionitrile, n- or iso-butyronitrile, (meth)acrylonitrile. If a solvent is used, the amount thereof is usually from 10 to 1000 wt. %, based on the amount of polyalkylene oxide to be prepared.

The choice of solvent or solvent mixture and the amount thereof is dependent on the optimum conditions for the subsequent copolymerisation of the polyalkylene oxide rubber with vinyl monomers.

The catalyst can be pre-activated before the reaction, so that the typical induction period in a discontinuous procedure of from several minutes to a few hours does not occur and the heat of reaction can be controlled by the metering of the monomers and dissipated via the solvent, which increases the safety of the process. In such cases, it is also possible to work under adiabatic conditions.

For the pre-activation of the catalyst system there are suitable epoxides, such as, for example, propylene oxide, 1-butene oxide, 1-pentene oxide, 1-hexene oxide, with preference being given to the higher boiling epoxides such as 1-hexene oxide. The pre-activation can optionally take place in the presence of a solvent or solvent mixture.

Suitable polyalkylene oxides B) have number-average molecular weights (M n) from 25,000 to 10,000,000 g/mol, particularly preferably from 30,000 to 1,000,000 g/mol, particularly preferably from 40,000 to 100,000 g/mol, and a heterogeneity \overline{M}_{w}/\overline{M}ₙ⁻1 from 0.5 to 10, preferably from 0.5 to 5, particularly preferably from 2 to 4.5, the glass transition of the rubber-like polymer being below −50° C., preferably below −60° C.

The polyalkylene oxides can be reacted via their hydroxy groups, for example with di- and poly-isocyanates or di- and poly-anhydrides, with an increase in the molar mass.

Suitable di- and poly-isocyanates are aliphatic, cycloaliphatic, arylaliphatic, aromatic and heterocyclic di- and poly-isocyanates, such as are described in Justus Liebigs Annalen der Chemie, Vol. 75, p. 562, 1949, for example those of the formula

Q(NCO)ₘ

wherein

m represents a number from 2 to 4, preferably 2, and

Q represents an aliphatic hydrocarbon radical having from 2 to 20 carbon atoms, preferably from 6 to 10 carbon atoms, a cycloaliphatic hydrocarbon radical having from 4 to 15 carbon atoms, preferably from 5 to 10 carbon atoms, an aromatic hydrocarbon radical having from 6 to 15 carbon atoms, preferably from 6 to 13 carbon atoms, or an arylaliphatic hydrocarbon radical having from 8 to 15 carbon atoms, preferably from 8 to 13 carbon atoms.

Preference is given to di- and poly-isocyanates such as are described in DE-A 28 32 253. Particular preference is generally given to the use of the di- and poly-isocyanates that are readily accessible commercially, for example 2,4- and 2,6-toluylene diisocyanate as well as any desired mixtures of those isomers (“TDI”), polyphenyl-polymethylene polyisocyanates, which are prepared by aniline-formaldehyde condensation and subsequent phosgenation (“crude MDI”), hexamethylene diisocyanate (“HDI”), and polyisocyanates containing carbodiimide groups, urethane groups, allophate groups, isocyanurate groups, urea groups or biuret groups (“modified polyisocyanates”).

Particular preference is given to polyisocyanates that are derived from 2,4- and/or 2,6-toluylene diisocyanate.

A chain lengthening can also be achieved by reaction with di- and poly-anhydrides, with polymaleic anhydrides being preferred.

The polyalkylene oxides B) can be polymerised or branched by free-radical reactions by way of the double bonds that are present.

The polyalkylene oxide rubber B) can be replaced up to an amount of 50 wt. % by other rubbers, for example by polydiene (e.g. polybutadiene, polyisoprene, polychloroprene, nitrile rubbers, hydrogenated nitrile rubbers), ethylene-alkene (EPM, LLDPE), ethylene-alkene-diene (EPDM), silicone, acrylate rubbers.

Polymerisation of the mixture of A) and B) can take place without a solvent, in solution or in suspension in water and in continuous or discontinuous processes. It is also possible to disperse component B) in water beforehand and subsequently react it further with the monomers A) in an emulsion polymerisation.

Component B) can be placed in a vessel in solution in one of the monomers A) or in a monomer mixture. Likewise, component B) can be dissolved in a suitable solvent, such as, for example, benzene, chlorobenzene, toluene, ethylbenzene, xylene, acetone, methyl ethyl ketone, diethyl ketone, ethyl acetate, methyl propioriate, and brought into contact with the vinyl monomers of component A). In that case, the vinyl monomers can also be metered in during the copolymerisation in a manner known to the person skilled in the art.

In the polymerisation, component B) is crosslinked and grafted with the vinyl monomers of component A).

The polymerisation is initiated by free radicals. Preference is given to the use of free-radical initiators which have grafting action and decompose at low temperatures, especially peroxides such as peroxo esters, peroxo carbonates, peroxo diesters, peroxo dicarbonates, diacyl peroxides, perketals, dialkyl peroxides and/or azo compounds, or mixtures thereof. Examples are, inter alia, tert-butyl perpivalate, peroctoate, perbenzoate, perneodecanoate, tert-butyl-2-ethylhexyl percarbonate, dibenzoyl peroxide or dicumyl peroxide. The initiators are used in amounts of from 0.01 to 2.5 wt. %, based on component A).

It is also possible, however, for component B) to be dispersed in water, with shear and optionally with the use of dispersing agents or emulsifiers known to the person skilled in the art, and reacted in dispersion or emulsion with the monomers of component A). Apart from organic free-radical generators, the initiators suitable for that reaction procedure are redox initiator systems which generally consist of an organic or inorganic oxidising agent and a reducing agent, as well as, optionally, additionally heavy metal ions.

Examples of suitable organic oxidising agents are di-tert-butyl peroxide, cumene hydroperoxide, dicyclohexyl percarbonate, tert-butyl hydroperoxide, p-menthane hydroperoxide, with cumene hydroperoxide and tert-butyl hydroperoxide being preferred. Suitable inorganic oxidising agents are, for example, inorganic peroxodisulfates such as sodium, potassium or ammonium peroxodisulfate and also H₂O₂.

Suitable reducing agents are water-soluble compounds such as, for example, salts of sulfinic acid, salts of sulfurous acid, sodium dithionite, sodium sulfite, sodium hyposulfite, sodium hydrogen sulfite, ascorbic acid and its salts, mono- and di-hydroxyacetone, sugars (e.g. glucose or dextrose), iron(II) salts such as, for example, FeSO₄, tin(II) salts such as, for example, SnCl₂, titanium(III) salts such as, for example, Ti₂(SO₄)₃.

The reaction temperature can be varied within wide limits. It is usually from 25 to 180° C., preferably from 50 to 170° C., particularly preferably from 70 to 160° C., and can also be varied during the polymerisation.

In a mass or solution process, the mixture containing components A) and B) is polymerised at least until phase inversion has been reached, preferably until the conversion of the monomers of component A) has reached values of from 30 to 100%, preferably from 50 to 95%. Phase inversion is understood as being the procedure whereby the rubber phase changes from the outer, coherent phase to the inner, divided phase and the other phase correspondingly changes from the inner, divided phase to the outer, coherent phase. After the phase inversion, the polymer obtained without a solvent or in solution can be suspended in water and the reaction continued in suspension.

During the polymerisation and prior to processing it is possible to add conventional additives, such as molecular weight regulators, such as, for example, mercaptans, allyl compounds, dimeric α-methylstyrenes, terpinols, as well as colourants, antioxidants, lubricants, such as, for example, hydrocarbon oils, stabilisers, etc.

Solvents, residual monomers and other volatile constituents (oligomers, molecular weight regulators) can be removed, once monomer conversions of from 50 to not more than 98% have been reached, by conventional techniques, for example using heat-exchange evaporators, screw-type evaporators, extrusion evaporators, thin-film or thin-layer evaporators.

The graft polymers prepared by the emulsion process can be worked up by known processes, for example by spray-drying or by addition of salts and/or acids, washing of the precipitated products and drying of the powder.

The graft polymers according to the invention can be processed with other polymers to form blends.

Suitable blend partners are, for example, selected from the group of the vinyl (co)polymers, polycarbonates, polyesters, polyester carbonates and polyamides.

The graft polymers according to the invention and their blends are distinguished by good low-temperature strength and improved resistance to thermal ageing and weathering.

They are suitable for the production of moulded bodies or semi-finished products by injection moulding or extrusion.

The invention is explained hereinbelow with reference to embodiments.

### EXAMPLES

The starting chemicals zinc chloride, potassium hexacyanocobaltate, tert-butanol, polypropylene glycol (\overline{M}ₙ=1000), allyl glycidyl ether, propylene oxide, MDI (4,4′-methylenediphenyl diisoycanate) were purchased from Aldrich (Taufkirchen, DE), and 1-hexene oxide, cholic acid Na salt and polyethylene glycol (\overline{M}ₙ=1000) were purchased from Fluka (Taufkirchen, DE) and used without further purification. The values for \overline{M}ₙ and \overline{M}_{w} were determined by gel permeation chromatography (GPC) in tetrahydrofuran (THF) at 25° C. with polystyrene calibration.

### Example 1

Copolymerisation of styrene and acrylonitrile with polypropylene oxide-co-allyl glycidyl ether

a) Activation of the Multi-Metal Cyanide Catalyst

20 mg of a multi-metal cyanide catalyst, prepared according to Example A of DE 199 20 937, are suspended in 40 ml of toluene in the course of 15 minutes by means of an ultrasonic bath, under argon. 0.3 g of polyethylene glycol starter (\overline{M}ₙ about 1000 g/mol, Aldrich) and 4 g of 1-hexene oxide (Aldrich) are added thereto and stirring is carried out for 3 hours at 110° C.

b) Copolymerisation of Propylene Oxide with Allyl Glycidyl Ether with Multi-Metal Cyanide Catalysis

1000 ml of toluene and 26.4 ml of catalyst solution from the above-described Example a) (containing 13 mg of the multi-metal cyanide catalyst) are placed in a 2 litre reactor and brought to 110° C. 480 g of monomer mixture, consisting of 448 g of propylene oxide (Aldrich) and 32 g of allyl glycidyl ether (Aldrich), are added thereto in the course of 3.5 hours, with vigorous stirring (150 rpm). When the addition of monomers is complete, the reaction mixture is stirred for a further 1.5 hours under reflux.

A slightly cloudy, viscous solution is obtained. The monomer conversion after 5 hours is 100%. The solvent is removed from the rubber-like polymer in vacuo at 50° C.

The following data are determined for the resulting polymer:

\overline{M}ₙ=50,000 g/mol

T_{g}=−70° C. (DSC, completely amorphous product)

c) Copolymerisation of Styrene and Acrylonitrile with Polypropylene Oxide-Co-Allyl Glycidyl Ether

117 g of the polymer described in Example 1b are dissolved at 80° C. in 274 g of toluene and placed in a 2 litre pressure reactor. The resulting solution is heated to 135° C. and the stirring speed is adjusted to 35 rpm. A solution consisting of 389 g of styrene and 138 g of acrylonitrile, and a solution consisting of 83 g of toluene and 1.37 g of tert-butylperoxo-(2-ethylhexyl) carbonate, are added synchronously and in parallel in the course of 85 minutes. The temperature is then raised to 165° C., and a solution consisting of 83 g of toluene and 0.53 g of di-tert-butyl peroxide is added rapidly to the reaction mixture. The reaction mixture is stirred at that temperature for a further 1.5 hours. The reaction mixture is then cooled and diluted at about 100° C. with 389 g of styrene and 138 g of acrylonitrile (monomer mixture as solvent). The conversion is 97%, based on the monomers originally used. Working up is carried out on a 32 mm twin-shaft equal twist screw.

The notched bar impact strength at room temperature (akRT) is determined on 80×10×4 mm test rods, processed at 240° C., in accordance with ISO 180/1A and is 14 kJ/m².

d) Copolymerisation of Styrene and Acrylonitrile with Polypropylene Oxide-Co-Allyl Glycidyl Ether

130 g of the polymer described in Example 1b are dissolved at 80° C. in 200 g of toluene, 195 g of styrene and 69 g of acrylonitrile and placed in a 2 litre pressure reactor. 0.26 of n-dodecylmercaptan (Aldrich) and 1.3 g of Irganox 1076 (Ciba Spezialitäten-Chemie) are added thereto, the resulting solution is heated to 120° C. and the stirring speed is adjusted to 20 rpm.

There are added in the course of 60 minutes a solution consisting of 100 g of toluene and 0.8 g of tert-butyl peroctoate and then, synchronously, a solution consisting of 195 g of styrene and 69 g of acrylonitrile and a solution consisting of 100 g of toluene and 0.5 g of tert-butyl peroctoate, in the course of 60 minutes. The temperature is then raised to 140° C., and a solution consisting of 100 g of toluene and 0.4 g of dicumyl peroxide is added rapidly to the reaction mixture. The reaction mixture is stirred at that temperature for a further 60 minutes. The reaction mixture is then cooled and diluted at about 100° C. with 389 g of styrene and 138 g of acrylonitrile (monomer mixture as solvent, preferred in an industrial process). The conversion is 90%, based on the monomers originally used. Working up is carried out on a 32 mm twin-shaft equal twist screw.

The notched bar impact strength at room temperature (aₖ^{RT}) is determined on 80×10×4 mm test rods, processed at 240° C., in accordance with ISO 180/1A and is 25 kJ/m².

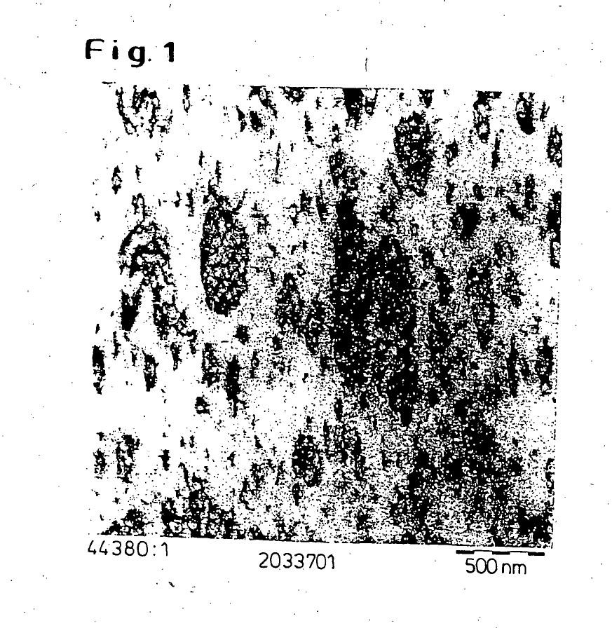

A transmission electron microscope image (FIG. 1) shows the morphology of the resulting graft polymer.

1. Graft polymers obtainable by polymerisation of a mixture containing
A) from 40 to 99 wt. % vinyl monomers and
B) from 1 to 60 wt. % of a double-bond-containing polyalkylene oxide rubber having a glass transition temperature below −50° C. and a number-average molecular weight of from 25,000 to 10,000,000.

2. Graft polymers according to claim 1, wherein component A) is selected from styrene, α-methylstyrene, 3-methylstyrene, 4-methylstyrene, indene, norbornene, acrylonitrile, methacrylonitrile, methyl methacrylate, maleic anhydride, maleimides, which may be substituted at the nitrogen atom by C₁- to C₁₈-alkyl or C₆- to C₁₀-aryl radicals, (meth)acrylic acid esters having from 1 to 18 carbon atoms in the alcohol component, and glycidyl methacrylate, as well as mixtures of those compounds.

3. Graft polymers according to claim 1, wherein component A) is selected from styrene, acrylonitrile and mixtures of those compounds.

4. Graft polymers according to claim 1, wherein component B) is obtainable by reaction of a mixture containing
I) from 80 to 99 parts by weight of one or more saturated epoxides,
II) from 1 to 20 parts by weight of one or more unsaturated epoxides,
III) from 0 to 10 parts by weight of epoxides having hydrolytically crosslinkable groups, and
IV) from 0 to 1 part by weight of one or more diepoxides,
in the presence of a multi-metal cyanide catalyst,
the sum of components I) to IV) being 100 parts by weight.

5. Graft polymers according to claim 4, wherein the multi-metal catalyst contains tert-butanol.

6. Process for the preparation of graft polymers according to claim 1, wherein a mixture containing
A) from 40 to 99 parts by weight of vinyl monomers and
B) from 1 to 60 parts by weight of a polyalkylene oxide having a glass transition temperature below −50° C. and a number-average molecular weight of from 25,000 to 10,000,000
is subjected to free-radical polymerisation.

7. Canceled.

8. Moulded bodies obtainable from graft polymers according to claim 1.
